(19) United States
(12) Patent Application Publication
(10) Pub. No.: US 2022/0355320 A1
(43) Pub. Date: Nov. 10, 2022

(54) CONTAINERS FOR FRAGRANCES

(71) Applicant: Viviana London Limited, Redditch, Worcestershire (GB)

(72) Inventor: Michael Edwards, Stevenage Hertfordshire (GB)

(21) Appl. No.: 17/623,344

(22) PCT Filed: Jun. 29, 2020
(86) PCT No.: PCT/GB2020/051569

§ 371 Date: Dec. 28, 2021

(30) Foreign Application Priority Data
Jun. 28, 2019 (GB) 1909302.0
Oct. 25, 2019 (GB) 1915549.8

(51) Int. Cl. B05B 7/24; B05B 12/14

(52) U.S. Cl. CPC B05B 7/2472; B05B 7/2464; B05B 12/1409; B05B 12/1418

(57) ABSTRACT

A container unit including a plurality of container sub-portions (4) defining a plurality of chambers for containing a liquid substance, each container sub-portion including an outlet, the container unit further including a conduit device (12) serving to connect each of the outlets of the respective sub-portions to an outlet nozzle (8a). In one embodiment, a spray cycle is disclosed having first and second periods of flow allowance and purging respectively. In another embodiment, respective sub-portion (4) controllable liquid displacement devices for dispensing one or more of the liquid substances selected from one or more of the respective sub-portions (4) are disclosed.

This invention relates to a container and particularly to a container for fragrances which are sprayed.

According to a first aspect of the present invention, there is provided a container unit including a plurality of container sub-portions defining a plurality of chambers for containing a liquid substance, each container sub-portion including an outlet, the container unit further including a conduit device serving to connect each of the outlets of the respective sub-portions to an outlet nozzle, a flow control device between the respective outlets and the conduit device, a pumping device connected to the conduit device, a spray actuator for dispensing one or more of the liquid substances from one or more of the respective sub-portions, and a source of energy connected to said pumping device, the arrangement being such that the source of energy provides energy to the pumping device not only to expel a liquid spray from an outlet nozzle in a first period of a spray cycle when respective flow control devices allow flow of their respective liquid substances from the respective sub-portion, but also to purge the conduit device of any residual liquid substance in the conduit device during a second period of the spray cycle which immediately follows the first period and during which the flow control devices prevent flow of their respective liquid substances from the respective sub-portion.

According to a second aspect of the present invention, there is provided a method of spraying one or more liquids, the method comprising selecting one or more of a plurality of container sub-portions of a container, unit each sub-portion containing a liquid substance, the method further comprising operating a pumping device connected to a source of energy by way of a spray actuator in order to dispense one or more of the liquid substances from one or more of the respective sub-portions, the arrangement being such that the source of energy provides energy to the pumping device not only to expel a liquid spray from an outlet nozzle in a first period of a spray cycle when respective flow control devices, located between each sub-container portion and a conduit device serving to connect respective outlets of each sub-portion, allow flow of their respective liquid substances from the respective sub-portion, but also to purge the conduit device of any residual liquid substance in the conduit device during a second period of the spray cycle which immediately follows the first period and during which the flow control devices prevent flow of their respective liquid substances from the respective sub-portion.

Owing to these aspects, an automatic pumping mechanism for a spray device can be provided in which the desired liquid or liquid mixture can be sprayed without being contaminated by a liquid or liquid mixture previously emitted from the container unit.

In one preferred embodiment of the container unit, a releasable connecting mechanism is provided for transferring the outlet of each sub-portion between a disengaged position and an engaged position, whereby operating the spray actuator dispenses one or more of the liquid substances from one or more of the respective sub-portions with their respective releasable connecting mechanisms in the engaged position. In this instance, the flow control device is a variable flow valve which could be of various suitable different types, such as a reed valve.

In another preferred embodiment, the flow control devices take the form of electronically operated valves.

Advantageously, each container sub-portion is removable from the container unit in order to be re-filled so as to re-use each sub-portion throughout the life of the unit.

Preferably, the source of energy is a source of electrochemical energy in the form of a suitable battery, which is advantageously but not necessarily rechargeable.

According to a third aspect of the present invention, there is provided a container unit including a plurality of container sub-portions defining a plurality of chambers for containing a liquid substance, each container sub-portion including an outlet, the container unit further including a conduit device serving to connect each of the outlets of the respective sub-portions to an outlet nozzle, respective sub-portion controllable liquid displacement devices associated with each outlet, a fluid displacing device connected to the conduit device, a spray actuator for dispensing one or more of the liquid substances selected from one or more of the respective sub-portions, and a source of energy connected to said fluid displacing device and said respective sub-portion controllable liquid displacement devices.

According to a fourth aspect of the present invention, there is provided a method of spraying liquid from a container unit including a plurality of container sub-portions defining a plurality of chambers for containing a liquid substance, each container sub-portion including an outlet, the container unit further including a conduit device serving to connect each of the outlets of the respective sub-portions to an outlet nozzle, the method comprising controlling respective sub-portion controllable liquid displacement devices associated with each outlet, operating a fluid displacing device connected to the conduit device, by way of a spray actuator for dispensing one or more of the chosen liquid substances selected from one or more of the respective sub-portions, wherein a source of energy is connected to said fluid displacing device and said respective sub-portion controllable liquid displacement devices.

Owing to this aspect, an automatic, precisely controlled pumping mechanism for a spray device can be provided.

Advantageously, the respective sub-container controllable liquid displacement devices are piezoelectric pumping devices.

The fluid displacing device is preferably a gas displacing device in the form of, for example, an air pumping device such that the source of energy provides energy to the pumping device not only to expel a liquid spray from an outlet nozzle in a first period of a spray cycle when respective sub-container controllable liquid displacement devices allow flow of their respective liquid substances from the respective sub-portion, but also to purge the conduit device of any residual liquid substance in the conduit device during a second period of the spray cycle which immediately follows the first period. In this way, the desired liquid or liquid mixture can be sprayed without being contaminated by a liquid or liquid mixture previously emitted from the container unit.

In order that the present invention can be completely understood, reference will now be made, by way of example only, to the accompanying drawings, in which:—

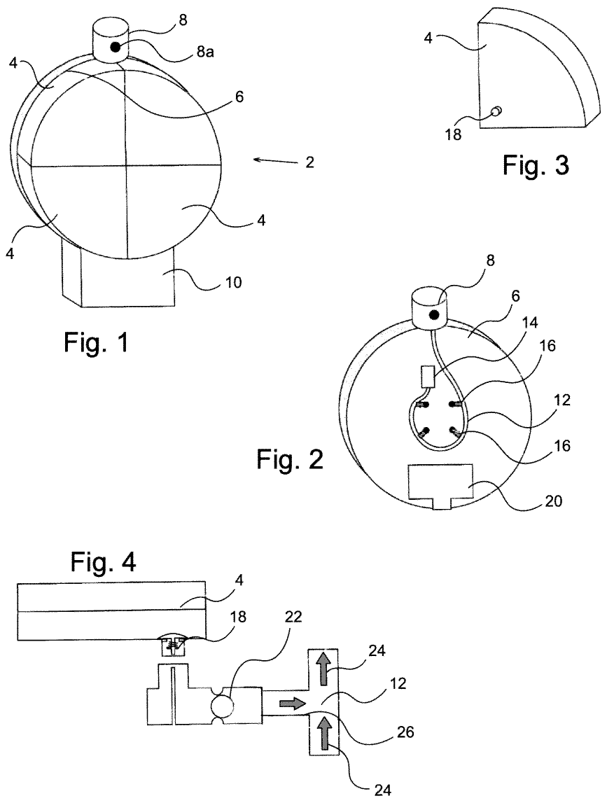

FIG. 1 shows a perspective view of a fragrance container comprising container sub-portions,

FIG. 2 shows a perspective view of the container of FIG. 1 with sub-portions removed from a base including a pumping device and a conduit device,

FIG. 3 shows a perspective view of a container sub-portion,

FIG. 4 shows a schematic cross-sectional view of a releasable connection mechanism between the sub-portion and a conduit device, and

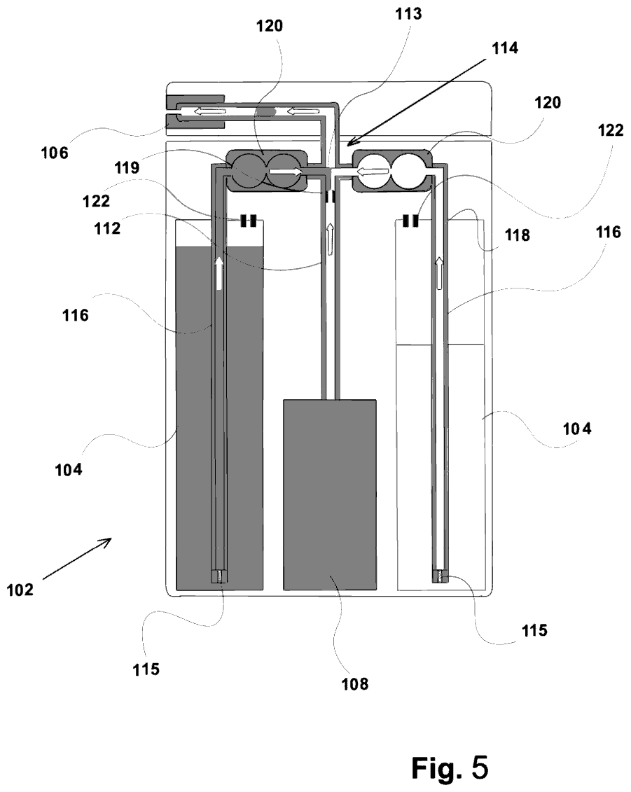

FIG. 5 shows a schematic view of an alternative fragrance container comprising container sub-portions.

Referring to FIG. 1, a container unit 2 comprises a plurality of container sub-portions 4, four such container sub-portions being shown, which form substantially equal chambers in which fragrant liquids, preferably different to each other, are stored, a base portion 6 to which the container sub-portions are connected, a spray actuator 8 having an outlet nozzle 8a and a connection means 10 for recharging an internal electrochemical battery.

Referring to FIG. 2, the base portion 6 has mounted thereto a conduit device 12, in the form of a suitably narrow tube in an open loop form, which connects all of the container sub-portions 4 with a pumping device 14 (also mounted to the base portion 6) at one end region of the conduit device 12 and the spray actuator 8 at the opposite end region of the conduit device 12. At the regions where each container sub-portion makes a fluid connection to the base portion 6 on the inside of the open loop, there is, in one preferred embodiment, a releasable connection mechanism 16. Operation of the releasable connection mechanism 16 transfers each sub-portion 4, independently of each other, from a disengaged position to an engaged position. In the disengaged position an outlet 18 of each sub-portion 4 (see FIG. 3) is not in fluid communication with the conduit device 12 and so no liquid enters the conduit device 12 if the spray actuator 8 is activated. Conversely, in the engaged position, the outlet 18 of each sub-portion 4 is in fluid communication with the conduit device 12 and so liquid does enter the conduit device 12 if the spray actuator 8 is activated. The nature of the releasable connecting mechanism can take any suitable form and is preferably of the type that is spring-biased similar to that of retractable pens or the like. The releasable connecting mechanism 16 can be either manually operated or automatically operated by way of an electrochemical battery 20 and rotary or linear actuators (not shown).

Referring to FIG. 4, the outlet 18 of each sub-portion 4 includes a first valve device which when the sub-portion 4 is in its disengaged position is closed to prevent the liquid contents of the sub-portion 4 from entering the conduit device 12. When the sub-portion 4 is transferred into the engaged position, the conduit device 12 acts upon the first valve device to open the first valve device and so establish fluid communication between the sub-portion 4 and the conduit device 12 by way of a second valve device which is in the form of a variable flow valve device 22. Once the spray actuator 8 is operated, one or more liquid substances from the sub-portions 4 in the engaged position exit the sub-portions via the respective outlets 18 and respective flow control devices in the form of variable flow valve devices 22 and enter the conduit device 12 from where they are sprayed through the outlet nozzle 8a into the surrounding atmosphere.

Internally of each sub-portion 4, there is advantageously a dip tube (not shown) that is connected to the outlet 18 so that substantially all of the liquid substance can be emptied from the sub-portion 4.

There could be sub-containers 4 of differing internal volumes depending, for instance, upon the different fragrances to be stored therein.

One type of mechanism of forming the output mist of one or more fragrances is by way of operating the spray actuator 8 to cause a stream of fluid, preferably air, to move along the conduit device 12 (in a direction indicated by the arrows 24 in FIG. 4) across a relatively small opening at an end region of a branch 26 of the conduit device 12, which branch leads to respective variable flow valve devices 22. At the junction between the branch 26 and the main part of the conduit device 12, which is preferably a substantially T-shaped junction, the air stream creates a lower pressure in the branch 26. The difference between the reduced pressure in the branch 26 and the higher atmospheric pressure existing inside the or each sub-portion 4 pushes the liquid through each branch 26 where the sub-portion is in the engaged position and into the moving stream of air in the main part of the conduit device 12 where it is carried away with the stream of air. Thus, for example, if the container 2 comprised four sub-portions 4 as shown, each in the engaged position, it would be possible to cause, upon actuation of the spray actuator 8, a stream of air to flow across all four branches 26 which would result in a mixture of the fragrances in each of the four sub-portions 4. The selective engagement and disengagement mechanism 16 enables the selection of any desired combination of the fragrances in each of the sub-portions 4. This would allow a user to mix in the case of four sub-containers 4 fifteen variations of fragrance. The sub-portions 4 are detachably connected to the base portion 6 and can be replaced to account for higher usage of a preferred fragrance.

The flow control devices 22 can be of any suitable form and may be a mechanically operated valve, such as a reed valve or the like, whereby when a stream of air is created in the conduit device by way of the actuator 8, a large enough pressure difference above a valve threshold is created to open the valve 22 of an engaged sub-portion 4 to allow the liquid substance to be sprayed.

Beneficially, a spray cycle is established in which during a first period of the spray cycle the pressure in the conduit device is greater than the valve threshold in order to extract the liquid substance of an engaged sub-portion 4, and in a second period, immediately following the first period, the pressure is lower than the valve threshold so that no further liquid substance is extracted from the engaged sub-portion owing to the fact that the valve 22 would have closed but is large enough to cause a purge of the conduit device so that no residual liquid substance remains in the conduit device that would contaminate a subsequent spray of different liquid substances. These first and second periods of the spray cycle are determined by the pumping device 14 which can be arranged or programmed to perform this spray cycle each time the actuator 8 is activated.

As an alternative to mechanically operated flow control devices 22, in another preferred embodiment electronically operated valves are employed instead. In this embodiment, the releasable connecting mechanism is not required and the electronically operated valves 22 could be operated in such a way that upon activation of the actuator 8, the pumping device 14 produces a substantially constant pressure in the conduit device 12 but the valves 22 are open for the first period of the spray cycle but closed for the second period of the spray cycle to allow for the purging of the conduit device 12. For example, if the spray cycle has a duration of 1 second, the first period may be 0.5 seconds immediately followed by the second period of 0.5 seconds. The electronically operated valves 22 could be controlled by an electronic valve controller which may be present in a software application stored in the memory of an electronic computer device such as a smartphone or tablet computer which is enabled to access the internet. The base portion 6 would, in this instance also include a microprocessor device to communicate with the electronic valve controller. In this way, it would be possible to open individual electronically operated valves 22 for different time periods of flow during the spray cycle so as to significantly increase the nature of mixtures of the liquid substances one can achieve. Thus, instead of evenly proportioned mixtures such as 50:50 with two liquid substances being mixed, it could be possible to have a mixture of 90:10, for instance. Furthermore, machine-readable codes, such as QR codes could be read by the microprocessor mentioned above to provide data for a particular mix of a suggested combination. In this way, the container unit 2 could determine a combination formula from a machine-readable source.

The electrochemical battery 20 is connected to the pumping device 14 to enable the pumping device 14 to operate upon actuation of the actuator 8. One main advantage of having an automatically powered pumping device is that, if a majority of the fragrances in the sub-portions are to be desired to mix, and the spray actuator is manually operated, then a significant amount of pressure is required on pressing the actuator to obtain an even mix of the fragrant liquids. The pumping device 14 enables the automatic generation of sufficient pressure in the conduit device 12 to achieve mixing of a majority of the fragrances. A further advantageous feature of the pumping device 14 is that with a manual device, once a mixture of the fragrances is sprayed there is always a residual amount of that mixture left in the conduit which then “spoils” the subsequent spray if a different combination is desired. The pumping device 14 enables the purging the conduit device 12 of substantially all of the desired mixture sprayed so that any residual liquid is so negligible so as not to affect the subsequent spray.

The battery 20 is advantageously rechargeable by way of the connection means 10 shown in FIG. 1, which could be connected to a charging base when required, which may be a plug-in charging base or a surface for wireless charging. Alternatively, a wired connection for charging the battery 20 could be made by any suitable means, such as a standard USB cable.

The dosage of individual fragrances in the sub-portions 4 may be metred electronically by way of the variable flow valve device 22 in such a way that an unequal mix is achieved; for example, 10% of a first fragrance, 50% of a second fragrance and 40% of a third fragrance. One advantageous way of providing such a mix is for the variable flow valve devices 22 to be electronically controlled with the software application stored in the memory of the electronic computer device such as a smartphone or tablet computer mentioned above. In this way, a user can input the particular fragrances present in the container unit 2 and control exact mixtures by programming a desired mixture into the software application, which is then communicated either wirelessly or via a wired connection to the container unit 2. That particular programmed mix can then be sprayed from the container unit 2. The software application may also provide suggested mixtures according to, for example, the season or time of the year. In addition, the microprocessor of the container unit 2 could store in its memory user pre-sets and/or combinations.

If necessary, one or more pressure or vacuum relief valves are to be provided to ensure control of the pressure in the container unit 2.

Each sub-portion 4 is removable from the container unit 2 as a whole so that they can be replaced and recycled. In this way, the same fragrances can be refreshed, or new combinations of fragrances can be arranged. This very advantageous arrangement enables freedom of choice and experimentation of different combinations of fragrances and allows the replacement of favourite fragrances and fragrance combinations. Thus, this feature allows a user who prefers one type of mix that will cause certain sub-portions 4 to run out quicker than others to be able to replace those sub-portions. As such the container unit 2 is ‘re-usable’.

Referring to FIG. 5, a container unit 102 comprises a plurality of substantially vertically oriented container sub-portions 104, two such container sub-portions 104 being shown, which form substantially equal chambers in which fragrant liquids, preferably different to each other, are stored, a spray actuator (not shown) having an outlet nozzle 106 and, optionally, a connection means for recharging an internal electrochemical battery (not shown). Preferably, there are four sub-portions 104 contained within the unit 102.

The sub-portions 104 are arranged about a central axis of the unit 102. A fluid displacing device in the form of an air pumping device 108 is located within the unit 102 and is powered by the internal battery. The pumping device 108 is connected to the outlet nozzle 106 by a suitably narrow central conduit 112 of a conduit device 114. Sub-portion conduit parts 116 of the conduit device 114 connect all of the sub-portions 104 with the spray actuator. Each conduit part 116 extends downwardly through an outlet 118 of each sub-portion 104 to a bottom region of the sub-portion's internal space. At the end of the conduit parts 116 of the conduit device 114 proximal the bottom of each sub-portion 104 are respective non-return valve devices 115 that simply allow the liquid contained therein to flow in one direction.

Located between the outlet 118 of each sub-portion 104 and the outlet nozzle 106, the conduit device 114 includes a sub-container controllable liquid displacement device 120, which is, advantageously a pumping device, and more particularly a compact, low power lightweight pump with a piezoelectric actuation mechanism. Such piezoelectric pumps 120 are preferably piezoelectric diaphragm micropumps which are controllable to transport desired amounts of the liquids. The functional principle the piezoelectric diaphragm pumps in combination with passive check valves is that a piezo ceramic is mounted on a coated brass membrane which is deformed when voltage is applied from the internal electrochemical battery. In the resulting down stroke, the liquid is being displaced out of the sub-portion 104. Check valves in the pump chamber define the flow direction. When the voltage decreases, the corresponding deformation causes an upstroke of the membrane. The liquid is sucked in and the pump chamber is filled again. In every second, the pump can be controlled to perform several hundred pumping cycles.

There could be sub-portions 104 of differing internal volumes depending, for instance, upon the different fragrances to be stored therein.

One type of mechanism of forming an output mist of one or more liquid fragrances is by way of operating the spray actuator to actuate the fluid displacement device 108 in order to cause a stream of fluid, preferably air, to move along the central conduit 112 and across a junction 113 with the outlet of the piezoelectric pumps 120, which is preferably a substantially T-shaped junction, the air stream creating a lower pressure in the central conduit 112. The difference between the reduced pressure in the in the central conduit 112 and the higher atmospheric pressure existing inside the or each sub-portion 104 pushes the liquid through the sub-portion conduit parts 116 and into the moving stream of air moving towards the outlet nozzle 108. A mixing chamber may optionally be included at the junction 113, but it is not necessary. A one-way valve device 119 is located in the central conduit 112 proximal to the junction 113 to prevent liquid from the sub-portions 104 in reaching the fluid displacement device 108.

The piezoelectric pumps 120 are controllable with a pump controller, the flow rate being varied by adjusting the applied voltage and frequency. The pump controller can take the form of a computer software program in the memory of a computer device which communicates with the piezoelectric pumps 120 by way of a wired or wireless connection. Such a computing device could be, for example, a mobile communications device such as a smartphone, tablet or wearable devices such as smart watches. The pump controller can therefore be programmed to communicate to each piezoelectric pump 120 a specific flow rate for the liquid in the associated sub-portion 104. In this way, different proportions of the liquids can be drawn from the sub-portions 104 to be expelled through the outlet nozzle 108 as single liquids (when 3 of the 4 piezoelectric pumps are set to be closed) or a mixture of the liquids from any combination of the 104 sub-portions. In this way, a very large number of combinations of the liquids is possible by the precise control of the piezoelectric pumps 120.

Thus, if the container unit 102 is comprised four sub-portions 104, with each piezoelectric pump 120 programmed to pump liquid therefrom, it would be possible to cause, upon actuation of the spray actuator, a stream of air to flow across all four intersections at the junction 113 in the conduit device 114 which would result in the precise programmed mixture of the fragrances in each of the four sub-portions 104 being sprayed from the outlet nozzle 106. The precise control of the piezoelectric pumps 120 enables the selection of any desired combination of the fragrance liquids in each of the sub-portions 104. This would not only allow a user to mix in the case of four sub-containers 104 fifteen variations of fragrance, but also many more variations by varying the amounts of each liquid in the mixture. The sub-portions 104 are, advantageously, detachably mounted in the unit 102 and can be replaced to account for higher usage of a preferred fragrance and for the experimentation with different liquids.

Similarly and as described above with reference to FIGS. 1 to 4, a spray cycle is established in which during a first period of the spray cycle extraction of the liquid substance of the or each sub-portion 104 occurs upon the programmed operation of the piezoelectric pumps 120, and in a second period, immediately following the first period, where the or each piezoelectric pump has precisely dosed the amount of liquid it was programmed to deliver and is therefore effectively closed to allow for a purge of the conduit device 114 so that no residual liquid substance remains in the conduit device that would contaminate a subsequent spray of different liquid substances. These first and second periods of the spray cycle are determined by the fluid displacement pumping device 108 which can also be arranged or programmed (by way of the previously mentioned computer software or different computer software) to perform this spray cycle each time the actuator is activated. For example, if the spray cycle has a duration of 1 second, the first period may be 0.5 seconds immediately followed by the second period of 0.5 seconds.

The container unit 102 could include a microprocessor device to communicate over an internet connection with the piezoelectric pumps 120. In this way, it would be possible to operate individual piezoelectric pumps 120 for variable control of the amount of liquid expelled from each sub-portion 104 so as to significantly increase the number and nature of mixtures of the liquid substances one can achieve. Thus, instead of evenly proportioned mixtures such as 50:50 with two liquid substances being mixed, it could be possible to have a mixture of 90:10, for instance. The dosage of individual fragrances from the sub-portions 104 may be metred electronically by way of the piezoelectric pumps 120 in such a way that an unequal mix is achieved; for example, 10% of a first fragrance, 50% of a second fragrance and 40% of a third fragrance. One advantageous way of providing such a mix is for the piezoelectric pumps 120 to be electronically controlled with the software application stored in the memory of the electronic computer device mentioned above. In this way, a user can input the particular fragrances present in the container unit 102 and control exact mixtures by programming a desired mixture into the software application, which is then communicated either wirelessly or via a wired connection to the container unit 102. That particular programmed mix can then be sprayed from the container unit 102. The software application may also provide suggested mixtures according to, for example, the season or time of the year. In addition, the microprocessor of the container unit 102 could store in its memory user pre-sets and/or combinations.

Moreover, the piezoelectric pumps 120 are further arranged to detect a flow of liquid therethrough so that the detection of a respective empty sub-portion 104 is possible.

Furthermore, machine-readable codes, such as QR codes could be read by the aforementioned microprocessor to provide data for a particular mix of a suggested combination. In this way, the container unit 102 could determine a combination formula from a machine-readable source.

The electrochemical battery is connected to the fluid displacement device 108 to enable the fluid displacement device 108 to operate upon actuation of the actuator. One main advantage of having an automatically powered pumping device is that, if a majority of the fragrances in the sub-portions are to be desired to mix, and the spray actuator is manually operated, then a significant amount of pressure is required on pressing the actuator to obtain an even mix of the fragrant liquids. The fluid displacement device 108 enables the automatic generation of sufficient pressure in the conduit device 114 to achieve mixing of a majority of the fragrances. A further advantageous feature of the fluid displacement device 108 is that with a manual device, once a mixture of the fragrances are sprayed there is always a residual amount of that mixture left in the conduit which then “spoils” the subsequent spray if a different combination is desired. The fluid displacement device 108 further enables the purging the conduit device 114 as aforesaid so that any residual liquid is so negligible that it does not substantially affect the subsequent spray.

The battery is advantageously rechargeable by way of a connection means (not shown), which could be connected to a charging base when required, which may be a plug-in charging base or a surface for wireless charging. Alternatively, a wired connection for charging the battery could be made by any suitable means, such as a standard USB cable.

If necessary, one or more pressure or vacuum relief valves 122 are to be provided to ensure control of the pressure in the sub-portions 104 by allowing atmospheric gases to enter the sub-portions 104 to prevent resistance when operating the spray actuator.

Each sub-portion 104 is removable from the container unit 102 as a whole so that they can be replaced and recycled. In this way, the same fragrances can be refreshed, or new combinations of fragrances can be arranged. This very advantageous arrangement enables freedom of choice and experimentation of different combinations of fragrances and allows the replacement of favourite fragrances and fragrance combinations. Thus, this feature allows a user who prefers one type of mix that will cause certain sub-portions 104 to run out quicker than others to be able to replace those sub-portions. As such the container unit 102 is ‘re-usable’.

1. A container unit including a plurality of container sub-portions defining a plurality of chambers for containing a liquid substance, each container sub-portion including an outlet, the container unit further including a conduit device serving to connect each of the outlets of the respective sub-portions to an outlet nozzle, a flow control device between the respective outlets and the conduit device, a pumping device connected to the conduit device, a spray actuator for dispensing one or more of the liquid substances from one or more of the respective sub-portions, and a source of energy connected to said pumping device, the arrangement being such that the source of energy provides energy to the pumping device not only to expel a liquid spray from an outlet nozzle in a first period of a spray cycle when respective flow control devices allow flow of their respective liquid substances from the respective sub-portion, but also to purge the conduit device of any residual liquid substance in the conduit device during a second period of the spray cycle which immediately follows the first period and during which the flow control devices prevent flow of their respective liquid substances from the respective sub-portion.

2. A container unit according to claim 1, and further comprising a releasable connecting mechanism for transferring the outlet of each sub-portion between a disengaged position and an engaged position, whereby operating the spray actuator dispenses one or more of the liquid substances from one or more of the respective sub-portions with their respective releasable connecting mechanisms in the engaged position.

3. A container unit according to claim 1, wherein the flow control device is a variable flow valve.

4. (canceled)

5. A container unit according to claim 1, wherein the flow control device is an electronically operated valve.

6. A container unit according to claim 5, wherein the electronically operated valve is controlled by an electronic valve controller.

7. A container unit according to claim 6, wherein the electronic valve controller is present in a software application stored in the memory of an electronic computer device.

8. A container unit according to claim 6, and further comprising a base portion, the base portion including a microprocessor device to communicate with the electronic valve controller.

9. (canceled)

10. (canceled)

11. (canceled)

12. A method of spraying one or more liquids, the method comprising selecting one or more of a plurality of container sub-portions of a container, each sub-portion containing a liquid substance, the method further comprising operating a pumping device connected to a source of energy by way of a spray actuator in order to dispense one or more of the liquid substances from one or more of the respective sub-portions, the arrangement being such that the source of energy provides energy to the pumping device not only to expel a liquid spray from an outlet nozzle in a first period of a spray cycle when respective flow control devices, located between each sub-container portion and a conduit device serving to connect respective outlets of each sub-portion, allow flow of their respective liquid substances from the respective sub-portion, but also to purge the conduit device of any residual liquid substance in the conduit device during a second period of the spray cycle which immediately follows the first period and during which the flow control devices prevent flow of their respective liquid substances from the respective sub-portion.

13. A method according to claim 12, and further comprising transferring the outlet of each sub-portion, by way of a releasable connecting mechanism, between a disengaged position and an engaged position, whereby operating the spray actuator dispenses one or more of the liquid substances from one or more of the respective sub-portions with their respective releasable connecting mechanisms in the engaged position.

14. A method according to claim 12, wherein during the first period of the spray cycle, the pressure in the conduit device is greater than a threshold of the flow control device in order to extract the liquid substance of an engaged sub-portion, and in the second period, the pressure is lower than the threshold so that no further liquid substance is extracted from the engaged sub-portion.

15. A method according to claim 12, wherein the first and second periods of the spray cycle are determined by the pumping device which can be arranged or programmed to perform the spray cycle each time the spray actuator is activated.

16. A method according to claim 12, wherein a dosage of individual liquid substances in the sub-portions may be metred electronically.

17. (canceled)

18. A container unit including a plurality of container sub-portions defining a plurality of chambers for containing a liquid substance, each container sub-portion including an outlet, the container unit further including a conduit device serving to connect each of the outlets of the respective sub-portions to an outlet nozzle, respective sub-portion controllable liquid displacement devices associated with each outlet, a fluid displacing device connected to the conduit device, a spray actuator for dispensing one or more of the liquid substances selected from one or more of the respective sub-portions, and a source of energy connected to said fluid displacing device and said respective sub-portion controllable liquid displacement devices.

19. A container unit according to claim 18, wherein the respective sub-container controllable liquid displacement devices are piezoelectric pumping devices.

20. A container unit according to claim 19, where in the piezoelectric pumping devices are piezoelectric diaphragm micropumps.

21. (canceled)

22. (canceled)

23. A container according to claim 18, wherein the fluid displacing device is a gas displacing device such that the source of energy provides energy to the pumping device not only to expel a liquid spray from the outlet nozzle in a first period of a spray cycle when respective sub-container controllable liquid displacement devices allow flow of their respective liquid substances from the respective sub-portion, but also to purge the conduit device of any residual liquid substance in the conduit device during a second period of the spray cycle which immediately follows the first period.

24. (canceled)

25. A container unit according to claim 19, wherein the piezoelectric pumping devices are controllable with a pump controller.

26. A container unit according to claim 25, wherein the pump controller is a computer software program in the memory of a computer device.

27. (canceled)

28. (canceled)

29. (canceled)

30. (canceled)

31. (canceled)

32. (canceled)

33. (canceled)
